(19) United States
(12) Patent Application Publication
(10) Pub. No.: US 2025/0028949 A1
(43) Pub. Date: Jan. 23, 2025

(54) OPTICAL NEURAL NETWORK WITH GAIN FROM PARITY TIME OPTICAL COUPLERS

(71) Applicant: University of Southern California, Los Angeles, CA (US)

(72) Inventors: Mercedeh KHAJAVIKHAN, Los Angeles, CA (US); Haoqin DENG, Los Angeles, CA (US)

(21) Appl. No.: 18/711,483

(22) PCT Filed: Nov. 18, 2022
(86) PCT No.: PCT/US2022/050425

§ 371 Date: May 17, 2024

Related U.S. Application Data
(60) Provisional application No. 63/281,053, filed on Nov. 18, 2021.

(51) Int. Cl. G06N 3/067; G06N 3/084

(52) U.S. Cl. CPC G06N 3/067; G06N 3/084

(57) ABSTRACT

An apparatus and methods are provided for an optical neural network architecture that utilizes parity-time (PT) symmetric couplers. The example PT symmetric optical neural network is based on layers using the PT symmetric couplers that each have two parallel waveguides. One waveguide applies gain while the other waveguide applies an equal loss to signals.

### PRIORITY CLAIM

This disclosure claims priority to and the benefit of U.S. Provisional Application No. 63/281,053, filed Nov. 18, 2021. The contents of that application in their entirety are hereby incorporated by reference.

### STATEMENT REGARDING FEDERALLY SPONSORED RESEARCH OR DEVELOPMENT

This invention was made with government support under Grant Nos. FA9550-20-1-0322 and FA9550-21-1-0202 awarded by Air Force Office of Scientific Research (AFOSR); W911NF-17-1-0481 awarded by Army Research Office; D18AP00058 awarded by Defense Advanced Research Projects Agency (DARPA); ECCS CBET 1805200, ECCS 2000538, and ECCS 2011171 awarded by National Science Foundation; N00014-19-1-2052, N00014-20-1-2522, and N00014-20-1-2789 awarded by Office of Naval Research; and BSF; 2016381 awarded by United States-Israel Binational Science Foundation (BSF). The government has certain rights in the invention.

### TECHNICAL FIELD

The present invention relates to optical neural networks, in particular, to an N-layer parity-time (PT)-symmetric optical neural network.

### BACKGROUND AND SUMMARY

The following description includes information that may be useful in understanding the present invention. It is not an admission that any of the information provided herein is prior art or relevant to the presently claimed invention, or that any publication specifically or implicitly referenced is prior art.

The computing power of modern electronics, which adopt the Von-Neumann architecture, is inherently bottlenecked by the data transfer rate between the processing and memory units. Emerging computing architectures, such as neuromorphic approaches, represent more effective computational schemes by intertwining logic with memory. In recent years, optical platforms have been proposed as promising candidates for fully or partially replacing electronic-based computing machines. Optical computing is particularly of interest because of the prospect of requiring lower energy per bit and having less latency. In 2017, a team of researchers from MIT demonstrated a ground-breaking, fully integrated optical neural network on a silicon chip by cascading a number of Mach-Zehnder interferometers (MZIs). An arbitrary matrix can be effectively mapped onto this optical neural network hardware by computing the corresponding phases of each MZI. For such networks, the required nonlinearities can be implemented through various approaches that utilize components such as intensity modulators, the saturation effect of cameras, quadratic nonlinearity of photodiodes, saturation of semiconductor amplifiers, and saturable absorbers. Since then, a number of schemes have been proposed to further optimize the implementation of these arrays and their on-chip training processes.

While optical neural networks are receiving considerable attention in both academic and industrial settings, it is now clear that changing phases on chip is undesirable and can significantly overshadow the potential benefits of the photonic accelerators. In these arrangements, phase changing is typically accomplished by thermo-optical phase shifters, where a bias current is applied to change the refractive index of an optical waveguide through the thermo-optic effect. However, since the thermo-optic coefficient of most optoelectronic materials is relatively small, translating a thermo-optic coefficient to a phase change requires a path length that is typically on the order of tens to hundreds of micrometers. Given that for processing N bits of data, O(N²) phase shifters are needed, such schemes can lead to prohibitively large structures as the size of the data increases. Moreover, the time it takes for the phase change to take effect is relatively long, on the order of tens of microseconds, which can limit the speed of on-chip training processes, where one needs to frequently vary phases to compute gradients. A number of recent works have aimed to address these problems by proposing alternative architectures that make use of optical fast Fourier transform (OFFT), ring resonators, acousto-optic modulators, and 3D printing. Other approaches based on phase-change materials, electro-absorption and electro-optic effect may also solve some of these issues, but the technology is still maturing.

However, the choice of cascaded passive MZIs for implementing optical neural networks is not related to the fundamentals of neural networks; rather, it comes from the mathematical convenience of expressing an arbitrary matrix into MZI-representable sub-systems through unitary matrices and singular value decomposition (SVD). It is well known that such unitary matrices can be readily implemented in passive optical platforms like silicon or silicon nitride wafers using a combination of MZIs. Nevertheless, since the original matrix (W_{i,j}) is generally non-unitary, amplification/attenuation has to inevitably be deployed in the optical implementation of ONNs. In addition, laser light is already used in such networks. With on-chip optical settings, lasing is typically achieved by pumping and carrier injection in appropriate III-V compound semiconductors. Moreover, saturable absorbers are considered as one of the choices for activation function in the optical domain. Most such elements are based on III-V semiconductors as well. Finally, as the network becomes larger, optical amplification may be needed in order to compensate the inevitable optical losses.

Thus there is a need for an optical neural network having gain/loss devices used in lieu of phase shifters. There is also a need for a basic component that significantly reduces energy consumption, increases training speed, and lowers the footprint of on-chip optical neural networks. There is also a need for an optical neural network that may be fabricated with III-V semiconductor materials on a silicon chip.

### SUMMARY

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

One disclosed example is a method for implementing a first layer of an optical neural network (ONN). Pixels of incoming data are encoded in light amplitude. Optical signals corresponding to the encoded pixels are sent to a first parity-time (PT) coupler. The optical signals passing through the first PT coupler are passed through an amplifier/attenuator. The signals are passed through a second PT coupler. The optical signals are passed to nonlinear elements (NE).

Another disclosed example is an optical neural network (ONN) including a light source configured to encode pixels of incoming data in light amplitude. The ONN has a first layer including a first parity-time (PT)-symmetric directional coupler configured to receive optical signals corresponding to the encoded pixels. The first layer includes an amplifier/attenuator configured to receive the optical signals passing through the first PT coupler. The first layer includes a second PT-symmetric directional coupler configured to receive the optical signals passing through the first PT coupler and the amplifier/attenuator. The first layer includes nonlinear elements configured to receive the optical signals passing through the first PT coupler, the amplifier/attenuator, and the second PT-symmetric directional coupler in the first layer of the ONN. The ONN has a second layer including photodetectors configured to receive the optical signals from the first layer of the ONN. The second layer includes a first parity-time (PT)-symmetric directional coupler configured to receive optical signals from the photodetectors. The second layer includes an amplifier/attenuator configured to receive the optical signals passing through the first PT coupler. The second layer includes a second PT-symmetric directional coupler configured to receive the optical signals passing through the first PT coupler and the amplifier/attenuator. The second layer includes nonlinear elements configured to receive the optical signals passing through the first PT coupler, the amplifier/attenuator, and the second PT-symmetric directional coupler in the second layer of the ONN. The ONN has an output layer of optical detectors.

### BRIEF DESCRIPTION OF DRAWINGS

In order to describe the manner in which the above-recited disclosure and its advantages and features can be obtained, a more particular description of the principles described above will be rendered by reference to specific examples illustrated in the appended drawings. These drawings depict only example aspects of the disclosure, and are therefore not to be considered as limiting of its scope. These principles are described and explained with additional specificity and detail through the use of the following drawings:

FIG. 1A shows a known Mach-Zehnder interferometer composed of two cascaded 50/50 beam splitters and a phase shifter;

FIG. 1B shows an example parity-time symmetric directional coupler, according to one or more embodiments of the present disclosure;

FIG. 2 shows the overall structure of an example 2-layer optical neural network based on arrays of parity time directional couplers, according to one or more embodiments of the present disclosure;

FIG. 3 a series of graphs for training and testing accuracies of different neural networks in comparison to the example 2 layer optical neural network, according to one or more embodiments of the present disclosure;

FIG. 4 is a confusion matrix from simulation of the example optical neural network, according to one or more embodiments of the present disclosure; and

FIG. 5 shows distribution of gain-loss contrast variable parameters (θ's) in the example optical neural network, according to one or more embodiments of the present disclosure.

### DETAILED DESCRIPTION

Unless defined otherwise, technical and scientific terms used herein have the same meaning as commonly understood by one of ordinary skill in the art to which this invention belongs. One skilled in the art will recognize many methods and materials similar or equivalent to those described herein, which could be used in the practice of the present invention. Indeed, the present invention is in no way limited to the methods and materials specifically described.

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The present disclosure relates to an optical neural network having an architecture based on parity-time (PT) symmetric couplers that address problems of current ONNs by using optical gain/loss in III-V semiconductors or other gain materials. The example architecture is a parity-time symmetric optical neural network (PT-ONN). The architecture has a cascading structure to ensure that a large number of free parameters are available and that the network is sufficiently expressive to distinguish patterns. Even at low/moderate levels of gain/loss contrast, the example neural network based on parity-time couplers can provide a comparable performance to that of passive optical systems with phase shifters. As will be shown, replacing phase shifters with PT-symmetric couplers significantly reduces energy consumption, increases training speed, and lowers the footprint of on-chip optical neural networks.

The main building block of the example parity-time symmetric optical neural network is a two-level parity-time symmetric directional coupler whose gain/loss factors can be tuned either individually or together. In general, a structure is considered to be parity-time symmetric if it is invariant under the simultaneous action of the P (space) and T (time) inversion operators. Despite having a non-Hermitian representation, these systems may still support entirely real spectra (eigenvalues). While originally developed in the context of quantum mechanics, PT-symmetric devices have been proposed in different areas of optics, including photonic lattices, micro resonators, gratings, sensors, wireless power transfer, and lasers. In optical settings, a structure is PT symmetric if the real part of the refractive index is an even function of space, while the imaginary component (representing gain and loss) exhibits an odd profile.

In this disclosure, a parity time coupler refers to a coupled waveguide system in which one channel experiences gain and the other one an equal amount of loss. Consequently, the propagation constants are the eigenvalues, and the electromagnetic modes represent the eigenvectors of the system. The ratio of gain-loss contrast to coupling serves as a parameter that largely determines the response of the structure. When this ratio becomes equal to unity, both eigenvalues and eigenvectors of the structure coalesce. This point that represents a spontaneous symmetry breaking is known as an exceptional point. In this example, the parity time couplers are operated in the parity time unbroken regime, where the governing parameter is less than unity and the system works below the exceptional point.

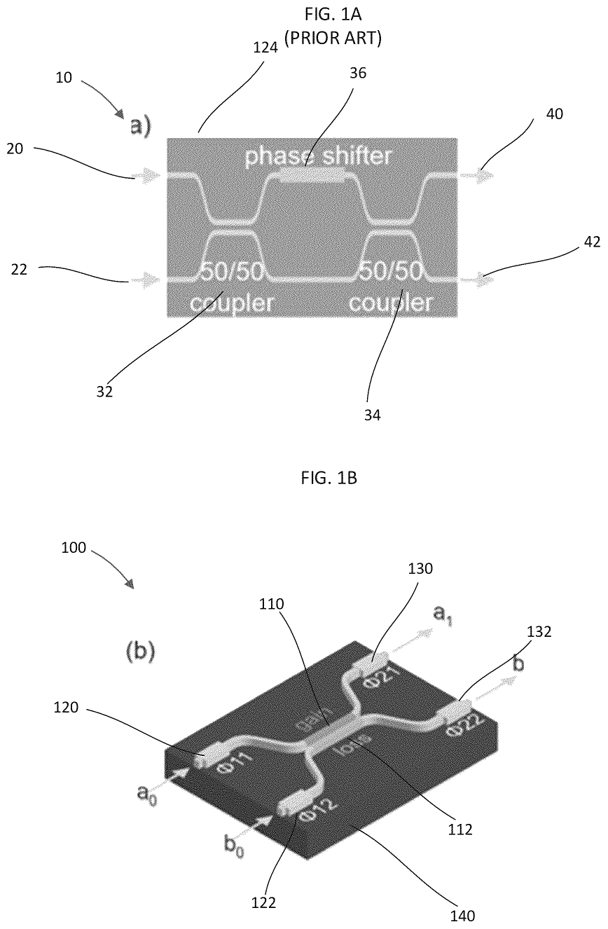

FIG. 1A shows a known Mach-Zehnder interferometer 10 that includes two inputs 20 and 22. The interferometer 10 includes of two cascaded 50/50 beam splitters 32 and 34. A phase shifter 36 is sandwiched in between the beam splitters 32 and 34. The interferometer 10 outputs the optical signal from two outputs 40 and 42.

FIG. 1B shows an example parity time symmetric directional coupler 100 having a pair of waveguides 110 and 112. An optical input signal may be fed into an input port 120 and the signal is output from an output port 130 of the waveguide 110. Similarly, a second optical input signal may be fed into an input port 122 and the signal is output from an output port 132 of the waveguide 110. The waveguide 110 experiences gain and the other waveguide 112 experiences a similar amount of loss. In this example, the waveguides 110 and 112 are fabricated using III-V semiconductor materials in a monolithic fashion. Other materials, such as InGaAsP quaternary compounds, may be used to fabricate the waveguides 110 and 112. The waveguides 110 and 112 of the PT-coupler 100 can be fabricated using a QWI (quantum well intermixing) method, which changes the refractive index of III-V materials through inducing defects, or selective area regrowth. This allows reduction of the loss on the waveguide sections 110 and 112. The PT-coupler 100 may be fabricated on a base 140, which in this example may be silicon. Waveguides that provide optical signals to and from the PT-coupler 100 may be fabricated in the base 140.

In a parity time-coupler such as the coupler 100, the energy exchange between the two waveguides 110 and 112 obey the following system of equations:

$$\{ \begin{matrix}i \frac{da}{dz} - i \frac{g}{2} a + κ b = 0 \\ i \frac{db}{dz} + i \frac{g}{2} b + κ a = 0\end{matrix} \qquad ( 1 )$$

where a and b represent the electric field in the two waveguides 110 and 112, κ is the coupling strength, z the propagation length, and g signifies the gain/loss contrast. The relationship between the input (a₀ and b₀) ports 120 and 122 and output (a and b) ports 130 and 132 may be derived in two different regimes of operation. For the parity time symmetry breaking point (where g/2κ≤1), the coupling matrix is expressed by:

$$[ \begin{matrix}a \\ b\end{matrix} ] = \frac{1}{cos θ} [ \begin{matrix}cos ( Z cos θ - θ ) & i sin ( Z cos θ ) \\ i sin ( Z cos θ ) & cos ( Z cos θ + θ )\end{matrix} ] [ \begin{matrix}{a}_{0} \\ {b}_{0}\end{matrix} ] , \qquad ( 2 )$$

where θ=sin⁻¹(g/2κ) and Z=κz. On the other hand, in the PT-broken phase (i.e., above the parity time symmetry breaking point) the parity time coupler behaves according to:

$$[ \begin{matrix}a \\ b\end{matrix} ] = \frac{1}{sinh η} [ \begin{matrix}sinh ( Z sinh η + η ) & i sinh ( Z sinh η ) \\ i sinh ( Z sinh η ) & sinh ( η - Z sinh η )\end{matrix} ] [ \begin{matrix}{a}_{0} \\ {b}_{0}\end{matrix} ] , \qquad ( 3 )$$

where g/2κ=cos h η. In both scenarios, the transfer matrices are non-unitary, due to the inherent non-Hermeticity of the device.

In this example, the parity time (PT) coupler 100 is exclusively used in the parity time unbroken phase. In other words, the gain-loss contrast in the system is only minimally perturbed around zero values (here g/2κ<0.2). By adding appropriate constant phases to the input (−π/2, −π) and output arms (π/2, π), respectively, the transfer function can be modified to only act in real space:

$$[ \begin{matrix}a \\ b\end{matrix} ] = \frac{1}{cos θ} [ \begin{matrix}cos ( Z cos θ - θ ) & - sin ( Z cos θ ) \\ sin ( Z cos θ ) & cos ( Z cos θ + θ )\end{matrix} ] [ \begin{matrix}{a}_{0} \\ {b}_{0}\end{matrix} ] . \qquad ( 4 )$$

In an example network having PT couplers such as the coupler 100 in FIG. 1B, a constant k and z are assumed for all couplers, where Z=κZ=1. This the gain-loss contrasts (g's) as the only on-chip parameters to be used for training (i.e. no phase modulation is required). This can be readily achieved in standard III-V semiconductor systems by pumping/carrier injection. Since varying gain/loss coefficients can be more efficient than changing phases in terms of space, power consumption, and speed, the example parity time optical neural network architecture has a smaller footprint and accelerates on-chip training at lower powers.

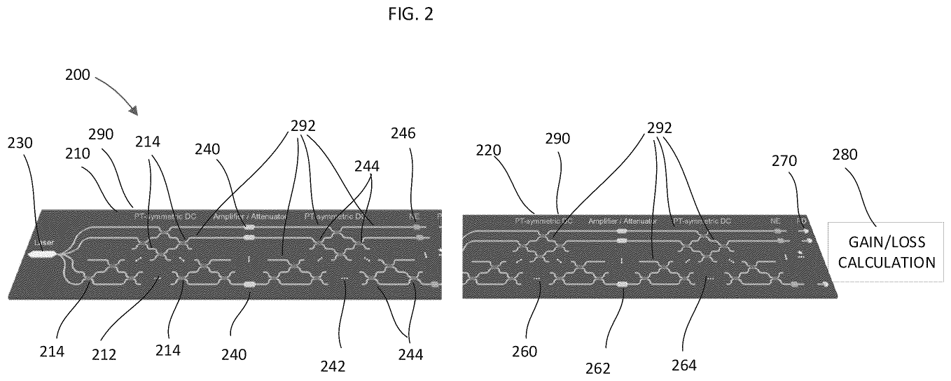

FIG. 2 shows a schematic of an example of a layer of a two-layer parity time symmetric optical neural network 200. The ONN 200 includes a first layer 210, and a second layer 220. A series of lasers 230 provides data inputs that are encoded by light amplitude. In the first layer 210 (layer 1), N₁ pixels of the incoming data are encoded in light amplitude provided by a series of laser sources/beams such as the lasers 230. After modulating the data on the carrier frequency via an off chip modulator and laser, the data travels in a triangular-shaped array 212 containing N₁(N₁−1)/2 parity time symmetric couplers 214. The output from the couplers 214 in the array 212 are fed into N₂ amplifiers/attenuators 240. The outputs from the amplifier/attenuators 240 are fed into another triangular-shaped array 242 containing N₂(N₂−1)/2 parity time symmetric couplers 244, and finally N₂ nonlinear elements 246.

The first layer 210 is followed by the second layer 220 (layer 2), which is similar to the first layer 210 in architecture. Thus, the second layer 220 has a triangular shaped array 260 of parity time symmetric couplers. The outputs from the nonlinear elements 246 of the first layer 210 are input into photodetectors to the parity-time symmetric couplers of the array 260. The outputs of the PT couplers in the array 260 are fed into N₃ amplifiers/attenuators 262. The output of the amplifier/attenuators 262 are fed into a second triangular shaped array 264. Thus, the second layer 220 has a different number of elements (N₂ and N₃ instead of N₁ and N₂) in comparison to the first layer 210. The second layer 220 ends in N₃ optical detectors 270. The output of the detectors 270 is then sent to an electronic circuit 280 to calculate the PT-coupler gain/loss parameters (θ's) in order to implement the gradient descent algorithm in the training cycles. In this example, N₁, N₂, N₃ are the sizes of the nodes in the input, hidden, and output layers, respectively.

The ONN 200 may be implemented with a multi-material platform on chip to achieve the desired functionalities. For example, the multi-material platform on chip may be via heterogeneous integration of III-V semiconductor materials on a silicon-on-insulator chip. Thus, the ONN 200 is fabricated on chip through an epitaxial regrowth process to form the PT couplers in the layers 210 and 220 on a silicon-on-insulator chip 290. The PT couplers of the layers 210 and 220 are realized in the III-V semiconductor materials and waveguiding sections 292 that couple the PT couplers in the layers 210 and 220 are implemented on the silicon layer of the chip 290.

The effectiveness of the ONN 200 may be demonstrated by simulations performed for a digit recognition task on a Modified National Institute of Standards and Technology (MNIST) dataset. To accomplish this, the 28×28-pixel images of the dataset were subsampled by a factor of 16 to be 7×7-pixel images for computing efficiency improvement. In this example an input layer of size 7×7 (N₁=49), a hidden layer of size N₂=20, and an output layer of N₃=10 dimensionality (corresponding to 10 digits) are used. A sigmoid activation function was used for the hidden layer. The hidden layer was used regardless of the hardware used for the implementation of the nonlinear function),

In this example a SoftMax activation function is used for the output layer, and cross-entropy as the loss function. The simulations were run with Python programs on an Intel i9-9900k CPU. It was assumed that all parameters are randomly initialized. For on-chip training, the numerical gradients of the designed parameters are computed using the finite difference method. By forward propagating the network with parameters θᵢ+Δθ and θᵢ−Δθ, the output may be measured. The equation f(θᵢ+Δθ) and f(θᵢ−Δθ) is computed, where f is the loss function that is going to be minimized. The partial gradient ∂f/∂θᵢ=(f(θᵢ+Δθ)−f(θᵢ−Δθ))/2Δθᵢ, is computed, the SGD (Stochastic Gradient Descent) is used to minimize the loss function.

To allow for appropriate benchmarking, in all the following experiments, a 2-layer neural network structure with the same topology is used, where there are N₁ input neurons, N₂ hidden neurons, N₃ output neurons, and the same set of activation and loss functions. The neural network topology was applied to three experimental settings, with different parameter spaces. First, a classical neural network with parameters being the weight matrix Wᵢⱼ for each layer was simulated. Then, an MZI-based optical neural network was modeled in which phases of the MZIs serve as the parameters. The MZI mesh was arranged in the triangular fashion, which uses singular-value decomposition (SVD). The schematic of this MZI-based ONN is similar to the PT based ONN 200 in FIG. 2. Finally, the MZIs were replaced with PT couplers as shown in the ONN 200 in FIG. 2. In this case the training parameters are gain/loss factors. The same topology of the mesh in the second and third simulations are used in order to allow a direct comparison to be made.

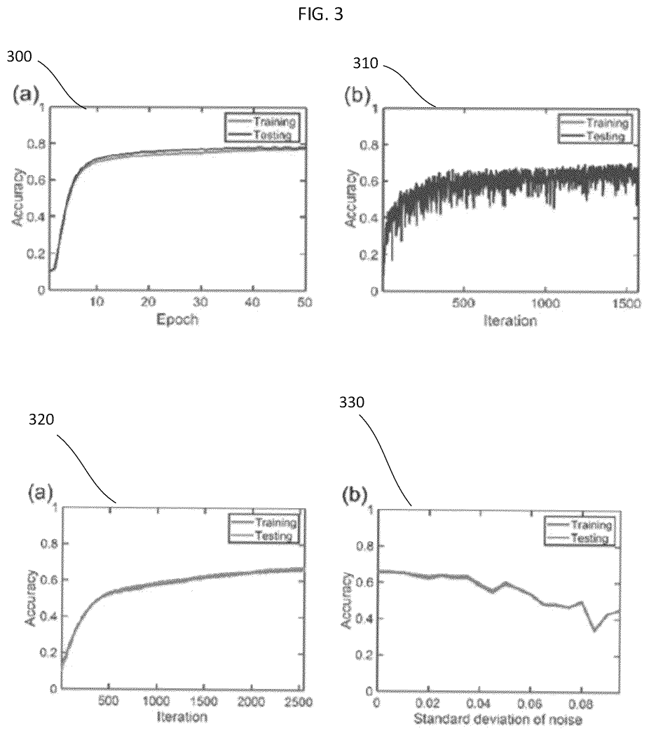

Using the traditional backpropagation method to compute gradients and the SGD (Stochastic Gradient Descent) method to minimize loss function, the three networks (classical, optical MZI network, and the example PT-ONN) were trained on the subsampled dataset and achieve a peak training accuracy of 77.5% and a testing accuracy of 78.5%. FIG. 3 shows a first graph 300 showing the training and testing accuracies using a back propagation method of the prior art classical neural network. A second graph 310 shows the training and testing accuracy of the optical network made of MZIs and using phase shifters as parameters. A third graph 320 shows the training and testing accuracy of the example optical network with parity time symmetrical couplers. A fourth graph 330 shows training and testing accuracies of the example PT-ONN in the presence of noise. In the graph 330, the accuracies are normalized against the zero-noise situation. This experiment served to validate the subsampled image set and the example two-layer neural network topology of the PT-ONN 200 in FIG. 2. The reported training and testing accuracies are considered to be the upper-bound for a network of the same topology (topology as in the number of layers, number of neurons in each layer, nonlinearities, and the loss function), since on-chip trainings that operate in different parameter spaces are generally expected to achieve lower accuracies.

The known optical neural network based on MZIs was tested by simulating the on-chip training process. More specifically, the transfer function between each layer was not represented by a single matrix; rather, it is the product of cascading 2-level transfer-matrices that represent MZIs, where the phases are the parameters to be trained. By training the network using the numerical method described above, a peak training accuracy of 69% and a peak testing accuracy of 70.2% was achieved as shown in the graph 310.

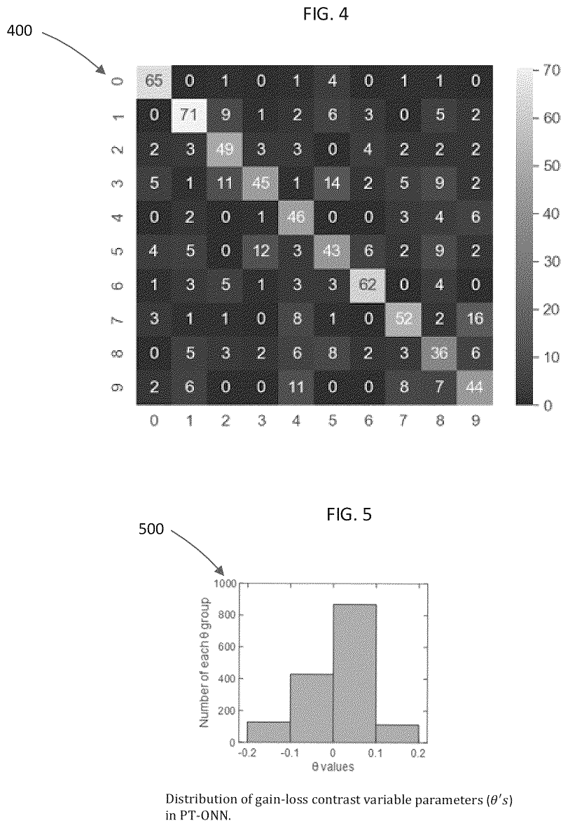

The performance of the PT-ONN architecture in FIG. 2 was evaluated, by choosing Z to be equal to 1. The on-chip training process is the same as above, except that the Stochastic Gradient Descent method was performed only on the gain/loss dependent θ variables. The simulations showed a peak testing accuracy of 66.5% and a peak training accuracy of 67.2% as shown in the graph 320. This result confirms that the example PT-ONN 200 is as expressive as the MZI based ONNs. A confusion matrix 400 is shown in FIG. 4. As can be seen in the matrix 400, most digits are correctly classified. Some pairs of confusion include (9, 4), (8, 3), (5, 3), (3, 2). Thus, the matrix 400 indicates that the example PT-ONN architecture performs as desired in relation to a level of error.

To further assess the robustness of the example PT-coupler based neural network architecture in FIG. 2, the PT-ONN was simulated under a noisy environment. Since the gain factors are used as training parameters, the variation of the gain factors was considered as the main source of error. For the evaluation, the gain contrast dependent parameters Os are perturbed by a gaussian distribution p(Δθᵢ)=exp (−Δθᵢ²/(2σ²))/\sqrt{2πσ}, where σ represents the strength of the noise. These perturbed 2-level systems will result in new transfer functions for the network. Under this scenario, the same technique was to simulate on-chip training and report the influence of noise level on the final training and testing accuracies as shown in the graph 330 in FIG. 3. As compared to the results from a passive on-chip optical convolutional neural network where the network has significant performance degradation when σ exceeds 0.01, the example ONN is more resilient to noise.

The example PT-ONN architecture using gain-loss contrast as the training parameter can achieve comparable on-chip training and testing accuracies to that reported in the ONNs composed of MZI devices with phase shifters. The example PT-ONN also shows robustness to variations of its parameters (θ's), in addition to having the advantages of smaller footprint, lower power consumption, and higher training speed.

In the example implementation of the PT-ONN in FIG. 2 the gain-loss constant parameters, |θ's| remained below 0.2. FIG. 5 shows a graph 500 of the distribution of the gain-loss contrast parameters (θ's), where most coefficients happen to be in the −0.1 to 0.1 range and the average θ value is approximately −2×10⁻⁴. Electromagnetic simulations show that a low to moderate level of gain will be adequate to reach the desired network performance. If the length of the coupling region is selected to be z=25 μm, the spacing between the two waveguides may be adjusted to tune the strength of the coupling coefficient (κ) in order to keep the required gain within the attainable range afforded by III-V semiconductor materials. For example, for a coupler operating at a wavelength of 1.55 μm, and a coupling coefficient of κ=4×10⁴ m⁻¹, the maximum required gain coefficient is γ=g/2=80 cm⁻¹, and the average gain per coupler is γ=g/2=20 cm⁻¹ (given that average value of |θ's| is 0.05), which are well within the attainable range in most InGaAsP quantum wells structures. The length of the coupler may be further reduced by choosing Z to be smaller than unity.

The phase-intensity coupling factor α refers to the effect of incurring a phase shift as a result of changing gain (Δn_r=αΔn_i). The PT couplers are operating in the PT-unbroken phase where the gain-loss contrast is relatively small and can be adjusted by varying the coupling. Since the length of the waveguides is small (on the order of 25 μm), this phase term is not of primary significance in the model. Assuming α=2, given that gain contrast has an upper bound of 80 cm\hat{ }(−1) as shown by the distribution of θ\hat{ }'s in the graph 500, the maximum accumulated phase per couple (for a 25 μm waveguide) will be on the order of 0.2 rad. This is of course the maximum accumulated phase per PT coupler. As shown in the table 500, θ's can take both positive and negative values, and the simulation shows that the average θ is on the order of −0.0002, resulting in very small overall average accumulated phase of 0.2 mrad, which is practically negligible.

The example PT-ONN was compared against the MZI-based network in terms of footprint, switching speed, and power consumption. Because they share the same network topology, individual PT and MZI blocks only were compared. The state-of-the-art Joule heaters are reported to have a it phase shift with a power requirement on the order of 20 mW and a switching time of a few microseconds, with the reported length of the heater to be a few hundreds of micrometer. In contrast, for the maximum gain of 80 cm⁻¹, a PT-coupler at a length of 25 μm requires ˜220 μW of power to amplify a 1 mW signal. However, the average power required for each PT-coupler is merely ˜50 μW. Even at a quantum efficiency of 10%, the required power is ˜0.5 mW, which is still considerably lower than what is reported for phase shifters. Semiconductor amplifiers can also be modulated at a sub-nanosecond time scale.

One additional benefit of this approach comes from implementing the entire PT-ONN using III-V semiconductor materials in a monolithic fashion. The required gain/loss can be achieved by pumping, and one possible candidate for realizing nonlinearity is saturable absorbers composed of III-V semiconductor materials. The III-V semiconductor material of such absorbers can also implement the nonlinear thresholding function, a necessary part of the ONN, on the same chip. Waveguides of the PT-couplers can be realized using a QWI (quantum well intermixing) method which changes the refractive index of III-V materials through inducing defects, or selective area regrowth. Finally, the detectors can be implemented on chip through an epitaxial regrowth process. With the advancements in heterogeneous integration, the example PT-coupler based ONN may be implemented with a multi-material platform on chip to achieve the desired functionalities.

The functionality of the symmetric PT-coupler remains primarily unaffected if one of the waveguides is nominally loss free (e.g., through intermixing) and gain/loss is applied exclusively to the other waveguide. Novel designs for PT-couplers that allow more fabrication-friendly arrangements may be used such as having the gain and loss in the waveguide arms.

Varying gain across the array is advantageous when compared to changing phases, in terms of time, power, and space management. Varying gain introduces extra noise due to spontaneous emission. In the gain region, electrons in the excited state could spontaneously drop to a lower state and emit photons that are not necessarily coherent with respect to the incoming signal. In addition, phase-intensity coupling can further complicate the training mechanism by introducing nonlinearity in the couplers. However, the example neural network based on PT-couplers is not severely affected by this effect due to the low average gain/loss contrasts.

The example PT symmetric optical neural network (PT-ONN) 200 is adequately expressive by performing the digit-recognition task on the modified national institute of standard and technology (MNIST) dataset. Compared to conventional ONNs, the PT-ONN achieves a comparable accuracy (67% vs. 71%) while circumventing the problems associated with changing phase. The example optical neural network based on parity time couplers allow for fast training in chip-scale optical neural networks because the gain and loss of the couplers fabricated from III-V semiconductor materials can be changed in the picosecond regime with a small amount of pump power.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

1. A method for implementing a first layer of an optical neural network (ONN), the method comprising:
encoding pixels of incoming data in light amplitude;
sending optical signals corresponding to the encoded pixels to a first parity-time (PT) coupler;
causing the optical signals passing through the first PT coupler to pass through an amplifier/attenuator;
passing the signals through a second PT coupler; and
passing optical signals to nonlinear elements (NE).

2. The method of claim 1, wherein the light amplitude is provided by a series of laser sources/beams wherein the pixels are encoded by lasers.

3. The method of claim 1, further comprising modulating the data on a carrier frequency prior to sending optical signals to the first PT coupler.

4. The method of claim 1, wherein the method is performed on a parity time-symmetric optical neural network (PT-ONN) having a first layer and a second layer, wherein the first layer includes the first and second PT couplers in a symmetrical arrangement.

5. The method of claim 1, wherein the first PT coupler and the second PT coupler each include a first waveguide experiencing gain and a second waveguide experiencing an equal amount of loss.

6. The method of claim 5, wherein the first and second PT couplers are fabricated from III-V semiconductor materials on a silicon-on-insulator chip, and wherein the waveguides are fabricated using quantum well intermixing to change the refractive index of the III-V materials.

7. (canceled)

8. (canceled)

9. The method of claim 4, wherein:
the encoding pixels comprises encoding N₁ pixels in the first layer such that the optical signals pass through the first PT coupler and the second PT coupler and encounter the nonlinear elements;
the first PT coupler is one of a triangular-shaped array of (N₁(N₁−1)/2) PT-symmetric directional couplers;
the second PT coupler is one of a triangular-shaped array of (N₂(N₂−1)/2) PT-symmetric directional couplers;
the amplifier/attenuator comprises N₂ amplifiers/attenuators; and
the NE comprise N₂ nonlinear elements; and wherein N₁ is a size of an input layer and N₂ is a size of the second layer, wherein the second layer is a hidden layer.

10. The method of claim 9, wherein the method further comprising:
encoding N₂ pixels of incoming data in light amplitude;
sending a second set of optical signals corresponding to the encoded N₂ pixels to a third PT coupler that is in a triangular-shaped array of (N₂(N₂−1)/2) PT-symmetric directional couplers in the second layer; and
causing the second set of optical signals passing through the third PT coupler to pass through one of N₃ amplifier/attenuators and then a fourth PT coupler that is in a triangular-shaped array of (N₃(N₃−1)/2) PT-symmetric directional couplers, the second set of optical signals fed into N₃ optical detectors, wherein N₃ is a size of an output layer.

11. The method of claim 10, wherein a sigmoid activation function is used for the second layer.

12. The method of claim 10, further comprising training the first layer including sending an output of the optical detectors to an electronic circuit to calculate PT-coupler gain/loss coefficients in training cycles for the first layer.

13. The method of claim 12, further comprising implementing a gradient descent algorithm in the training cycles using the calculated PT-coupler gain/loss coefficients.

14. An optical neural network (ONN) comprising:
a light source configured to encode pixels of incoming data in light amplitude;
a first layer including:
a first parity-time (PT)-symmetric directional coupler configured to receive optical signals corresponding to the encoded pixels;
an amplifier/attenuator configured to receive the optical signals passing through the first PT coupler;
a second PT-symmetric directional coupler configured to receive the optical signals passing through the first PT coupler and the amplifier/attenuator;
nonlinear elements configured to receive the optical signals passing through the first PT coupler, the amplifier/attenuator, and the second PT-symmetric directional coupler in the first layer of the ONN;
a second layer including:
photodetectors configured to receive the optical signals from the first layer of the ONN,
a first parity-time (PT)-symmetric directional coupler configured to receive optical signals from the photodetectors;
an amplifier/attenuator configured to receive the optical signals passing through the first PT coupler;
a second PT-symmetric directional coupler configured to receive the optical signals passing through the first PT coupler and the amplifier/attenuator;
nonlinear elements configured to receive the optical signals passing through the first PT coupler, the amplifier/attenuator, and the second PT-symmetric directional coupler in the second layer of the ONN; and
an output layer of optical detectors.

15. The optical neural network of claim 14, wherein:
the first layer constitutes an input layer having a size of N₁ the second layer constitutes a hidden layer having a size of N₂ and the optical detectors constitute an output layer having a size of N₃,
the first PT-symmetric directional coupler is one of an array of (N₁(N₁−1)/2) PT-symmetric directional couplers;
the amplifier attenuator and optical detectors are one of N₂ amplifier/attenuators and optical detectors,
the second PT-symmetric directional coupler, and the photodetectors in the second layer are (N₂(N₂−1)/2), N₃, (N₃(N₃−1)/2), and N₃, respectively, and

16. The optical neural network of claim 14, wherein the light source is a series of laser sources, wherein the pixels are encoded by lasers.

17. The optical neural network of claim 14, further comprising a laser modulator modulating the data on a carrier frequency prior to sending optical signals to the first PT coupler.

18. The optical neural network of claim 14, wherein the PT couplers each include a first waveguide experiencing gain and a second waveguide experiencing an equal amount of loss.

19. The optical neural network of claim 18, wherein the PT couplers are fabricated from III-V semiconductor materials fabricated on a silicon-on-insulator chip.

20. The optical neural network of claim 18, wherein the waveguides are fabricated using quantum well intermixing to change the refractive index of the III-V semiconductor materials.

21. (canceled)

22. The optical neural network of claim 21, wherein the PT couplers of the first and second layers are fabricated on the silicon through an epitaxial regrowth process.

23. The optical neural network of claim 14, wherein the neural network is trained via implementing a gradient descent algorithm in training cycles using PT-coupler gain/loss coefficients.
